(19) United States
(12) Patent Application Publication
(10) Pub. No.: US 2025/0335749 A1
(43) Pub. Date: Oct. 30, 2025

(54) LEVERAGING GENERATIVE ARTIFICIAL INTELLIGENCE TO GENERATE CONTENT CORRESPONDING TO A PERSONA

(71) Applicant: Global Prairie PBC, Inc., Kansas City, MO (US)

(72) Inventors: Douglas R. BELL, Westlake, OH (US); Steven Frank DAVIS, La Veta, CO (US)

(21) Appl. No.: 18/644,695

(22) Filed: Apr. 24, 2024

(51) Int. Cl. G06N 3/0475

(52) U.S. Cl. CPC G06N 3/0475

(57) ABSTRACT

Generative artificial intelligence (AI) is leveraged to generate content corresponding to a persona. Context comprising a persona and a prompt is received from a user. The context is provided to a generative AI model. Based on the context, content at least partially derived from one or more files in a dataset is received from the generative AI model. The content corresponding to the context is provided to the user.

### BACKGROUND

Vast amounts of electronic data are available via a number of sources. The data can be structured or unstructured multimodal data such as presentations, portable document format (PDFs), documents, spreadsheets, images, videos, audio, plain text, and the like. From internal corporate data to news related data to social media data via numerous data sources in numerous formats, the process of curating data into meaningful information requires extensive resources. Moreover, presenting the information in the proper context requires a comprehensive understanding of the underlying data and insight into how the presentation is likely to be received by the intended audience.

### SUMMARY

At a high level, aspects described herein relate to transforming data into predictive insights with generative artificial intelligence (AI). More particularly, aspects described herein leverage generative AI to generate content corresponding to a persona. In accordance with aspects of the technology described herein, context comprising a persona and a prompt is received from a user. The prompt is provided to a generative AI model. Based on the prompt, content at least partially derived from one or more files in a dataset is received from the generative AI model. The content corresponding to the context is provided to the user.

The Summary is intended to introduce a selection of concepts in a simplified form that is further described in the Detailed Description of this disclosure. The Summary is not intended to identify key or essential features of the claimed subject matter, nor is it intended to be used as an aid in determining the scope of the claimed subject matter. Additional objects, advantages, and novel features of the technology will be provided, and in part will become apparent to those skilled in the art upon examination of the disclosure or learned through practice of the technology.

### BRIEF DESCRIPTION OF THE DRAWINGS

The present technology is described in detail below with reference to the attached drawing figures, wherein:

FIG. 1 is a block diagram of an example operating environment suitable for implementing aspects of the technology;

FIG. 2 is a flow diagram showing a method for generating a database comprising vector representations describing content corresponding to one or more files in a dataset, in accordance with an aspect of the technology described herein;

FIG. 3 is a flow diagram showing a method for leveraging generative AI to generate content corresponding to a persona, in accordance with an aspect of the technology described herein; and

FIG. 4 is an example computing device suitable for implementing the described technology, in accordance with an aspect described herein.

### DETAILED DESCRIPTION

While data mining technology can be an incredibly useful tool for searching and analyzing large sets of data, shortcomings in existing data mining technologies often result in the consumption of an unnecessary quantity of computing resources (e.g., I/O costs, network packet generation costs, throughput, memory consumption, etc.). When attempting to transform large amounts of data into meaningful insights, users are often seeking to present the insights to a specific target audience or to elicit a particular response. For instance, in the context of anticipating reactions from news outlets or individuals in terms of tone and voice based on past writing and knowledge, the user may be seeking to generate a forward-looking narrative. In another example, in the context of executive summaries, the user may be seeking to distill and summarize vast amounts of text into a concise summary that is in a tone and voice appropriate for a particular executive. Existing search technologies are unable to understand the context desired by the user and the resulting data transformation is not particularly helpful, which then requires the user to employ additional resources or utilize a trial-and-error approach to achieve the desired result.

For example, in the context of a marketing campaign, the user may desire to present internal data to a particular, specialized audience, such as a row crop farmer. Existing technologies may enable the user to sort through vast amounts of internal data that can be presented to the row crop farmer. However, existing technologies are unable to do so in a voice and tone that resonates with the row crop farmer. In this regard, the user is left to make an educated guess about what data to present or must engage in A/B testing or a similar approach to determine what data and in what tone and voice is most effective.

Now imagine a scenario, where instead of a marketing campaign, the user desires to present to the same audience, but in a Request for Proposal (RFP). In this scenario, the user may only have one opportunity to present a winning proposal. As can be appreciated, an educated guess or A/B testing is not practical in this instance.

Even when various approaches and testing are practical, these processes unnecessarily consume various computing resources of the systems being leveraged, such as processing power, network bandwidth, throughput, memory consumption, etc. In some instances, the multiple attempts to identify the appropriate data in the appropriate context may even completely fail to satisfy the user's goal, thus requiring the user to spend even more time and computing resources on the process by repeating the process of searching for additional data and leveraging additional testing until the user finally generates appropriate and effective content. In some cases, the user may even give up because the systems are unable to achieve desired search results.

These shortcomings of existing technologies adversely affect computer network communications. For example, each time an interaction is received, contents or payload of the interactions is typically supplemented with header information or other metadata, which is multiplied by all the additional interactions needed to obtain the particular content in the particular tone and voice the user desires. As such, there are throughput and latency costs by repetitively generating this metadata and sending it over a computer network. In some instances, these repetitive interactions increase storage device I/O (e.g., excess physical read/write head movements on non-volatile disk) because each time a user inputs unnecessary information, the computing system often has to reach out to the storage device to perform a read or write operation, which is time consuming, error prone, and can eventually wear on components, such as a read/write head. This decreases throughput and increases network latency, and can waste valuable time.

Aspects of the technology described herein improve the functioning of the computer itself in light of these shortcomings in existing technologies by providing a solution that enables a content engine to generate content corresponding to a persona (i.e., a desired tone and voice) by leveraging generative AI. This enables the user to generate content in the desired tone and voice with a single interaction. As can be appreciated, better results are achieved compared to traditional systems that require multiple interactions from the user and the use of additional systems and/or testing.

Aspects of the technology described herein provide a number of improvements over existing technologies. For instance, computing resource consumption is improved relative to existing technologies. In particular, by leveraging generative AI, the user may efficiently generate content corresponding to a persona. This eliminates (or at least reduces) the repetitive user interactions because the content does not have to be rewritten or tested. Accordingly, aspects of the technology described herein decrease computing resource consumption, such as processing power and network bandwidth. For instance, a user interaction (e.g., an HTTP request), would only need to traverse a computer network once (or fewer times relative to existing technologies).

In like manner, aspects of the technology described herein improve storage device or disk I/O and query execution functionality. As described above, the inadequate results provided by existing technologies results in repetitive user interactions and/or testing. This causes multiple traversals to disk I/O. In contrast, aspects described herein reduce storage device I/O because the user provides a reduced amount of inputs so the computing system does not have to reach out to the storage device as often to perform a read or write operation. For example, by leveraging generative AI, the content engine can respond with content tailored to the context provided by the user (i.e., corresponding to a persona and a prompt). Accordingly, there is not as much wear due to query execution functionality.

Having briefly described an overview of aspects of the technology described herein, an exemplary operating environment in which aspects of the technology described herein may be implemented is described below.

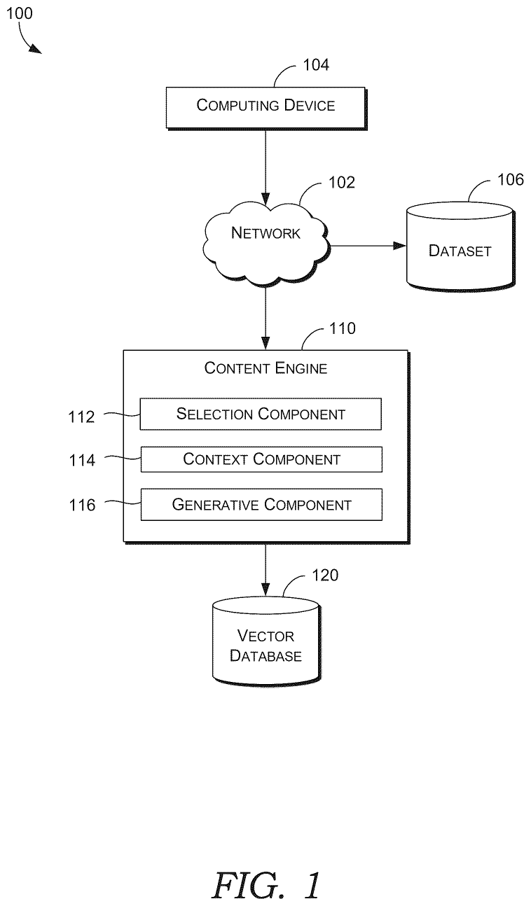

Turning now to FIG. 1, a block diagram is provided showing an operating environment 100 in which aspects of the present disclosure may be employed. It should be understood that this and other arrangements described herein are set forth only as examples. Other arrangements and elements (e.g., machines, interfaces, functions, orders, and groupings of functions) can be used in addition to or instead of those shown, and some elements may be omitted altogether for the sake of clarity. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, some functions may be carried out by a processor executing instructions stored in memory.

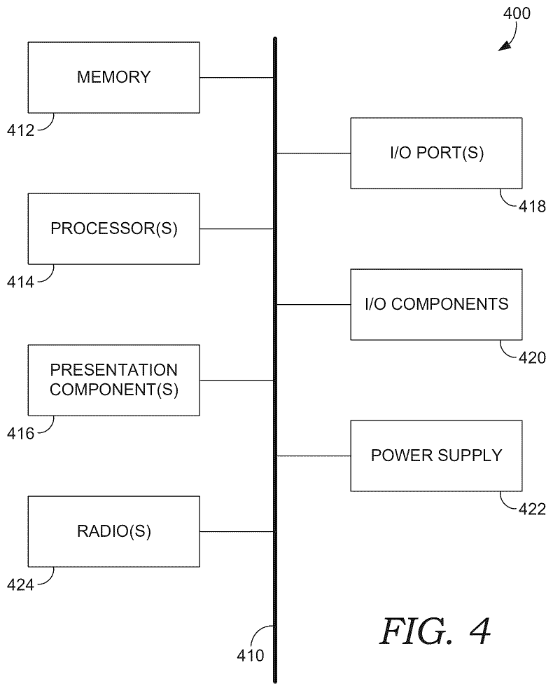

Among other components not shown, example operating environment 100 includes a network 102; a computing device 104; dataset 106; content engine 110 having a selection component 112, a context component 114, and a generative component 116; and vector database 120. It should be understood that environment 100 shown in FIG. 1 is an example of one suitable operating environment. Each of the components shown in FIG. 1 may be implemented via any type of computing device, such as computing device 400, described below in connection to FIG. 4, for example.

These components may communicate with each other via the network 102, which may include, without limitation, one or more local area networks (LANs) and/or wide area networks (WANs). In exemplary implementations, the network 102 comprises the Internet and/or a cellular network, amongst any of a variety of possible public and/or private networks. In aspects, the network 102 may include multiple networks, as well as being a network of networks, but is shown in more simple form so as to not obscure other aspects of the present disclosure.

It should be understood that any number of user devices, servers, and data sources may be employed within the operating environment 100 within the scope of the present disclosure. Each may comprise a single device or multiple devices cooperating in a distributed environment. For instance, the content engine 110 may be provided via multiple devices arranged in a distributed environment that collectively provide the functionality described herein. Additionally, other components not shown may also be included within the distributed environment.

The computing device 104 can be a client device on the client-side of the operating environment 100, while the content engine 110 can be on the server-side of operating environment 100. For example, the content engine 110 can comprise server-side software designed to work in conjunction with client-side software on the computing device 104 so as to implement any combination of the features and functionalities discussed in the present disclosure. This division of the operating environment 100 is provided to illustrate one example of a suitable environment, and there is no requirement for each implementation that any combination of the content engine 110 and the computing device 104 remain as separate entities. While the operating environment 100 illustrates a configuration in a networked environment with a separate computing device, content engine, dataset, and vector database, it should be understood that other configurations can be employed in which components are combined. For instance, in some configurations, a computing device may also serve as a data source and/or may provide some or all capabilities described as being associated with content engine.

The computing device 104 may comprise any type of computing device capable of use by a user. For example, in one aspect, the computing device 104 may be the type of computing device 400 described in relation to FIG. 4 herein. By way of example and not limitation, a computing device may be embodied as a personal computer (PC), a laptop computer, a mobile or mobile device, a smartphone, a tablet computer, a smart watch, a wearable computer, a personal digital assistant (PDA), an MP3 player, global positioning system (GPS) or device, video player, handheld communications device, gaming device or system, entertainment system, vehicle computer system, embedded system controller, remote control, appliance, consumer electronic device, a workstation, or any combination of these delineated devices, or any other suitable device where actions described herein may be performed via a client interface of computing device 104 or where content can be presented via a client interface component of computing device 104. A user may be associated with the computing device 104. The user may communicate with the content engine 110 through one or more computing devices, such as the computing device 104.

At a high level, the content engine 110 receives context from a user. The context may comprise a persona and a prompt. A persona, as used herein, corresponds to a target demographic of the content generated by content engine 110. A persona may further represent a tone and voice of the content generated by content engine 110. The prompt is provided to a generative AI model, along with the persona, and the generative AI model generates content at least partially derived from one or more files in a dataset, such as dataset 106. The content engine 110 provides the content corresponding to the context to the user via user interface of computing device 104.

In some configurations, the content engine 110 may be embodied on one or more servers. In other configurations, the content engine 110 may be implemented at least partially or entirely on a user device, such as computing device 400 described in FIG. 4. The content engine 110 (and its components) may be embodied as a set of compiled computer instructions or functions, program modules, computer software services, or an arrangement of processes carried out on one or more computer systems.

As shown in FIG. 1, the content engine 110 includes the selection component 112, the context component 114, and generative component 116. In one aspect, the functions performed by components of the content engine 110 are associated with one or more personal assistant applications, services, or routines. In particular, such applications, services, or routines may operate on one or more user devices (such as computing device 104) or servers (e.g., the content engine 110), or may be distributed across one or more user devices and servers. In some aspects, the applications, services, or routines may be implemented in the cloud. Moreover, in some aspects, these components of the content engine 110 may be distributed across a network, including one or more servers and client devices (such as computing device 104), in the cloud, or may reside on a user device such as computing device 104.

In addition, the components of the content engine 110 and the functions and services performed by these modules may be implemented at appropriate abstraction layer(s) such as an operating system layer, an application layer, or a hardware layer, etc. Alternatively, or in addition, the functionality of these modules (or the aspects of the technology described herein) can be performed, at least in part, by one or more hardware logic components. For instance, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. Further, although functionality is described herein with regards to specific modules shown in content engine 110, it is contemplated that in some aspects, functionality of one of the modules can be shared or distributed across other modules.

The content engine 110 may cause one or more graphical user interface displays of various computing devices to display the selection of files, the context comprising the persona and the prompt, and the content. In aspects, content engine 110 causes a client interface component of computing device 104, through which the context is input, the selection of files, the context comprising the persona and the prompt, and the content. Further, the content engine 110 may comprise an Application Program Interface (API) that allows applications to submit selection of files and/or the context comprising the persona and the prompt for receipt by the content engine 110.

The selection component 112 may initially receive a selection of one or more files in a dataset, such as dataset 106. The dataset may include any number of files in any number of formats. The selection component 112 may extract text from the one or more files and convert the extracted text into vector representations describing content corresponding to the one or more files. For non-text based files, the selection component 112 may extract metadata or may convert visual or other characteristics of the files into vector representations describing the non-textual content. The selection component may generate a database, such as vector database 120, comprising the vector representations.

The context component 114 may be configured to receive context from the user. The context may comprises a persona and a prompt. As described, the persona corresponds to a target demographic and may include a desired tone and voice of the content being generated. The context component 114 provides the context to a generative AI model.

The generative component 116 may be configured to generate, based on the context, content at least partially derived from the one or more files in the dataset. To do so, the generative component 116 utilizes the vector representations in the vector database 120 to identify relevant data corresponding to the prompt and generates the content according to the desired persona.

The generative module 116 utilizes a machine learning model to generate content based on the context. In some aspects, one or more portions of the context may be determined by the machine learning model. For example, the machine learning model (or a second machine learning model) may be trained to identify a persona based on the vector representations in the vector database. To do so, the vector database may include information that enables the machine learning model to predict characteristics of the persona that will be helpful in generating content targeting a similar persona using vector representations in another vector database. In another example, the machine learning model may determine an appropriate prompt based on the vector representations in the vector database. In this regard, the vector database may include data that enables the machine learning model to predict a prompt that can be used to generate content using vector representations in another vector database.

The generative component 116 comprises any type of generative AI model that uses neural networks to identify patterns and structures within existing data to generate new and original content corresponding to a particular context. Although described as a single machine learning model, the generative component 116 may be a series of machine learning models working together to generate content corresponding to the context.

The dataset 106 and vector database 120 may comprise data sources or data systems, which are configured to make data available to any of the various constituents of operating environment 100. The dataset 106 and vector database 120 may be discrete components separate from content engine 110 or may be incorporated or integrated into the content engine 110 or other components the operating environment 100. Among other things, vector database 120 can store vector representations corresponding to data in dataset 106.

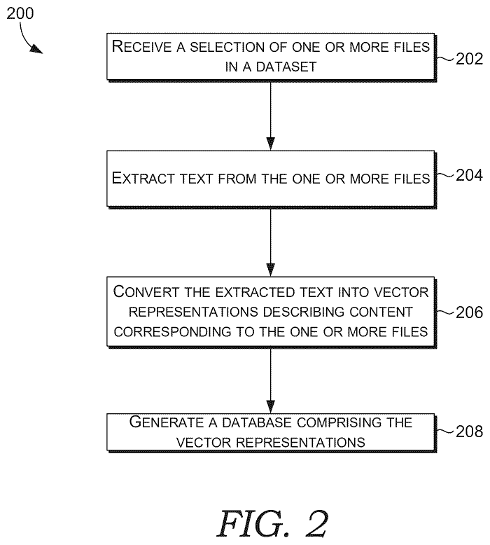

FIG. 2 is a flow diagram showing a method 200 for leveraging generative AI to identify products for completing a task, in accordance with an aspect of the technology described herein. The method 200 may be performed, for instance, by the content engine 110 of FIG. 1.

As shown at block 202, a selection of one or more files in a dataset is initially received from a user. The files may include any number of files in any number of formats. In aspects, the selection of the one or more files may be selected from dataset 106 and received at content engine 110 via a client interface of computing device 104 of FIG. 1.

At block 204, text is extracted from the one or more files. For non-text based files, metadata may be extracted or visual or other characteristics of the files may be leveraged to describe the non-textual content.

At block 206, the extracted text (or metadata or visual or other characteristics) is converted into vector representations describing content corresponding to the one or more files.

At block 208, a database is generated, such as vector database 120, comprising the vector representations.

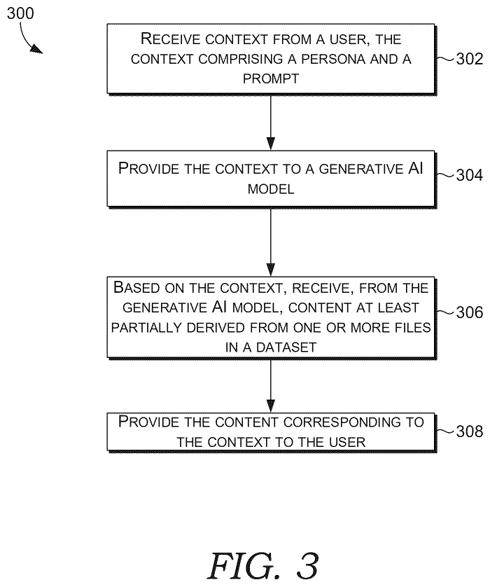

FIG. 3 is a flow diagram showing a method 300 for leveraging generative AI to generate content corresponding to a persona, in accordance with an aspect of the technology described herein. The method 300 may be performed, for instance, by the content engine 110 of FIG. 1. In aspects, a context may be received at a search engine 108 via client interface component of computing device 104 of FIG. 1.

As shown at block 302, context is received from a user. The context comprises a persona and a prompt. In aspects, the persona corresponds to a target demographic and may include a desired tone or voice (e.g., in a courtroom setting, the persona could be directed to a particular juror or judge). For example, the persona may include a particular executive in an organization. In another example, the persona may include a particular vocation. In yet another example, the persona may include an imaginary person from a particular region of the country. In yet another example, the persona may include a particular news organization.

In aspects, the prompt provides instructions to the generative AI model regarding the type of content to be generated. For example, the prompt may instruct the generative AI model to identify themes and topics of the one or more files. In another example, the prompt may instruct the generative AI model to distill and summarize the one or more files into an executive summary (or continuing the example above, to distill and summarize the one or more files into themes and topics that may resonate with the particular juror or judge). In yet another example, the prompt may instruct the generative AI model to pinpoint a specific file of the one or more files. In another example, the prompt may instruct the generative AI model to generate a predictive narrative.

At block 304, the context is provided to a generative AI model.

At block 306, based on the context, content at least partially derived from the one or more files in the dataset is received from the generative AI model.

At block 308, the content corresponding to the context is provided to the user. In one aspect, the content is an advertisement corresponding to the one or more files based on a perspective of the persona. In another aspect, the content is a portion of a website corresponding to the one or more files based on a perspective of the persona. In yet another aspect, the content is a reaction to information corresponding to the one or more files based on a perspective of the persona. In another aspect, the content is a predictive narrative corresponding to the one or more files based on a perspective of the persona. In yet another aspect, the content is media training support corresponding to the one or more files based on a perspective of the persona. In various aspects, the content is themes and topics of the one or more files, an executive summary, a specific file, or a predictive narrative.

With reference to FIG. 4, computing device 400 includes a bus 410 that directly or indirectly couples the following devices: memory 412, one or more processors 414, one or more presentation components 416, one or more input/output (I/O) ports 418, one or more I/O components 420, and an illustrative power supply 422. Bus 410 represents what may be one or more busses (such as an address bus, data bus, or combination thereof). Although the various blocks of FIG. 4 are shown with lines for the sake of clarity, in reality, these blocks represent logical, not necessarily actual, components. For example, one may consider a presentation component such as a display device to be an I/O component. Also, processors have memory. The inventors hereof recognize that such is the nature of the art and reiterate that the diagram of FIG. 4 is merely illustrative of an exemplary computing device that can be used in connection with one or more aspects of the present technology. Distinction is not made between such categories as “workstation,” “server,” “laptop,” “handheld device,” etc., as all are contemplated within the scope of FIG. 4 and with reference to “computing device.”

Computing device 400 typically includes a variety of computer-readable media. Computer-readable media can be any available media that can be accessed by computing device 400 and includes both volatile and nonvolatile media, removable and non-removable media. By way of example, and not limitation, computer-readable media may comprise computer-storage media and communication media.

Computer-storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVDs) or other optical disk storage, magnetic cassettes, magnetic tape, magnetic disk storage or other magnetic storage devices, or any other medium which can be used to store the desired information and which can be accessed by computing device 400. Computer storage media does not comprise signals per se.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, RF, infrared, and other wireless media. Combinations of any of the above should also be included within the scope of computer-readable media.

Memory 412 includes computer storage media in the form of volatile and/or nonvolatile memory. The memory may be removable, non-removable, or a combination thereof. Exemplary hardware devices include solid-state memory, hard drives, optical-disc drives, etc. Computing device 400 includes one or more processors 414 that read data from various entities such as memory 412 or I/O components 420. Presentation component(s) 416 presents data indications to a user or other device. Exemplary presentation components include a display device, speaker, printing component, vibrating component, and the like.

The I/O ports 418 allow computing device 400 to be logically coupled to other devices, including I/O components 420, some of which may be built in. Illustrative components include a microphone, joystick, game pad, satellite dish, scanner, printer, wireless device, etc.

The I/O components 420 may provide a natural user interface (NUI) that processes air gestures, voice, or other physiological inputs generated by a user. In some instances, inputs may be transmitted to an appropriate network element for further processing. An NUI may implement any combination of speech recognition, touch and stylus recognition, facial recognition, biometric recognition, gesture recognition both on screen and adjacent to the screen, air gestures, head and eye tracking, and touch recognition associated with displays on the computing device 400. The computing device 400 may be equipped with depth cameras, such as stereoscopic camera systems, infrared camera systems, RGB camera systems, and combinations of these, for gesture detection and recognition. Additionally, the computing device 400 may be equipped with accelerometers or gyroscopes that enable detection of motion. The output of the accelerometers or gyroscopes may be provided to the display of the computing device 400 to render immersive augmented reality or virtual reality.

Some aspects of computing device 400 may include one or more radio(s) 424 (or similar wireless communication components). The radio 424 transmits and receives radio or wireless communications. The computing device 400 may be a wireless terminal adapted to receive communications and media over various wireless networks. Computing device 400 may communicate via wireless protocols, such as code division multiple access (“CDMA”), global system for mobiles (“GSM”), or time division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (i.e., a primary connection and a secondary connection). A short-range connection may include, by way of example and not limitation, a Wi-Fi® connection to a device (e.g., mobile hotspot) that provides access to a wireless communications network, such as a WLAN connection using the 802.11 protocol; a Bluetooth connection to another computing device is a second example of a short-range connection, or a near-field communication connection. A long-range connection may include a connection using, by way of example and not limitation, one or more of CDMA, GPRS, GSM, TDMA, and 802.16 protocols.

Referring to the drawings and description in general, having identified various components in the present disclosure, it should be understood that any number of components and arrangements might be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, or software. For instance, various functions may be carried out by a processor executing instructions stored in memory. As such, other arrangements and elements (e.g., machines, interfaces, functions, orders, and groupings of functions, etc.) can be used in addition to or instead of those shown.

Embodiments described above may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of the present technology is described with specificity herein to meet statutory requirements. However, the description itself is not intended to limit the scope of this disclosure. Rather, the inventors have contemplated that the claimed or disclosed subject matter might also be embodied in other ways, to include different steps or combinations of steps similar to the ones described in this document, in conjunction with other present or future technologies. Moreover, although the terms “step” or “block” might be used herein to connote different elements of methods employed, the terms should not be interpreted as implying any particular order among or between various steps herein disclosed unless and except when the order of individual steps is explicitly stated.

For purposes of this disclosure, the word “including,” “having,” and other like words and their derivatives have the same broad meaning as the word “comprising,” and the word “accessing” comprises “receiving,” “referencing,” or “retrieving,” or derivatives thereof. Further, the word “communicating” has the same broad meaning as the word “receiving,” or “transmitting,” as facilitated by software or hardware-based buses, receivers, or transmitters” using communication media described herein.

In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present technology are described with reference to a distributed computing environment. However, the distributed computing environment depicted herein is merely an example. Components can be configured for performing novel aspects of embodiments, where the term “configured for” or “configured to” can refer to “programmed to” perform particular tasks or implement particular abstract data types using code. Further, while embodiments of the present technology may generally refer to the distributed data object management system and the schematics described herein, it is understood that the techniques described may be extended to other implementation contexts.

From the foregoing, it will be seen that this technology is one well adapted to attain all the ends and objects described above, including other advantages that are obvious or inherent to the structure. It will be understood that certain features and subcombinations are of utility and may be employed without reference to other features and subcombinations. This is contemplated by and is within the scope of the claims. Since many possible embodiments of the described technology may be made without departing from the scope, it is to be understood that all matter described herein or illustrated by the accompanying drawings is to be interpreted as illustrative and not in a limiting sense.

What is claimed is:

1. A method of leveraging generative artificial intelligence (AI) to generate content corresponding to a persona, the method comprising:
receiving context from a user, the context comprising a persona and a prompt;
providing the context to a generative AI model;
based on the context, receiving, from the generative AI model, content at least partially derived from one or more files in a dataset; and
providing the content corresponding to the context to the user.

2. The method of claim 1, further comprising receiving a selection of the one or more files in the dataset.

3. The method of claim 2, further comprising extracting text from the one or more files.

4. The method of claim 3, further comprising converting the extracted text into vector representations describing content corresponding to the one or more files.

5. The method of claim 4, further comprising generating a database comprising the vector representations.

6. The method of claim 1, wherein the persona corresponds to a target demographic.

7. The method of claim 1, wherein the context instructs the generative AI model to identify themes and topics of the one or more files.

8. The method of claim 1, wherein the context instructs the generative AI model to distill and summarize the one or more files into an executive summary.

9. The method of claim 1, wherein the context instructs the generative AI model to pinpoint a specific file of the one or more files.

10. The method of claim 1, wherein the context instructs the generative AI model to generate a predictive narrative.

11. The method of claim 1, wherein the content is an advertisement corresponding to the one or more files based on a perspective of the persona.

12. The method of claim 1, wherein the content is a portion of a website corresponding to the one or more files based on a perspective of the persona.

13. The method of claim 1, wherein the content is a reaction to information corresponding to the one or more files based on a perspective of the persona.

14. The method of claim 1, wherein the content is a predictive narrative corresponding to the one or more files based on a perspective of the persona.

15. The method of claim 1, wherein the content is media training support corresponding to the one or more files based on a perspective of the persona.

16. One or more non-transitory computer storage media storing computer-readable instructions that when executed by a processor, cause the processor to perform operations, the operations comprising:
receiving context from a user, the context comprising a persona and a prompt, wherein the persona corresponds to a target demographic;
providing the context to a generative AI model, wherein the context instructs the generative AI model to:
identify themes and topics of one or more files in a dataset;
distill and summarize the one or more files into an executive summary;
pinpoint a specific file of the one or more files; or
generate a predictive narrative corresponding to the one or more files;
based on the context, receiving, from the generative AI model, content; and
providing the content corresponding to the context to the user.

17. The one or more non-transitory computer storage media of claim 16, further comprising receiving a selection of the one or more files in the data set.

18. The one or more non-transitory computer storage media of claim 17, further comprising further comprising:
extracting text from the one or more files; and
converting the extracted text into vector representations describing content corresponding to the one or more files.

19. The one or more non-transitory computer storage media of claim 18, further comprising further comprising generating a database comprising vector representations corresponding to extracted text of the one or more files in the dataset.

20. A system for leveraging generative artificial intelligence (AI) to identify products for completing a task, the system comprising:
at least one processor; and
one or more computer storage media storing computer-readable instructions that when executed by the at least one processor, cause the at least one processor to perform operations comprising:
receiving context from a user, the context comprising a persona and a prompt;
providing the context to a generative AI model;
based on the context, receiving, from the generative AI model, content at least partially derived from one or more files in a dataset; and
providing the content corresponding to the context to the user, wherein the content is an advertisement, a portion of a website, a reaction to information, a predictive narrative, or media training support corresponding to the one or more files based on a perspective of the persona.
